(19) United States
(12) Patent Application Publication
(10) Pub. No.: US 2006/0088713 A1
(43) Pub. Date: Apr. 27, 2006

(54) Surface modification of nanocrystals using multidentate polymer ligands

(76) Inventors: Tieneke Emily Dykstra, Lynden (CA); Xiao-Song Wang, Toronto (CA); Mayrose Ramos Salvador, Toronto (CA); Gregory Denton Scholes, Toronto (CA); Mitchell Alan Winnik, Toronto (CA); Jung Kwon Oh, Toronto (CA)

Correspondence Address: Ralph A. Dowell of DOWELL & DOWELL P.C., 2111 Eisenhower Ave, Suite 406, Alexandria, VA, 22314, US

(21) Appl. No.: 11/122,235

(22) Filed: May 5, 2005

Related U.S. Application Data
(60) Provisional application No. 60/567,778, filed on May 5, 2004.

(51) Int. Cl. B32B 27/14; B01F 3/12; B32B 33/00

(52) U.S. Cl. 428/402; 516/33

(57) ABSTRACT

The present invention provides a method of surface passivation of colloidal nanocrystalline materials using a ligand exchange process in which quantum nanoparticles of pre-selected size and shape has polymer multidentate ligands bound at the surface of the nanocrystals for stabilizing quantum size-dependent properties of nanocrystals and providing colloidal stability of the nanoparticles in solvents. The method includes preparing a colloidal dispersion of nanoparticles, preparing a suitable polymer multidentate ligand and dissolving said suitable polymer multidentate ligand in a fluid, the polymer multidentate ligand having first portions which can bind to a surface of the nanoparticles and a second portion which does not bind to the surface of the nanoparticles, and mixing the fluid containing the suitable polymer with the colloidal dispersion of nanoparticles under conditions suitable to induce binding of at least some of the first portions of the polymer multidentate ligand onto the surface of the nanoparticles, the suitable polymer multidentate ligand being selected so that the at least some of the first portions which bind to the surface to stabilize quantum size-dependent properties of the nanocrystals, and the second portion which does not bind to the surface provides colloidal stability of the nanoparticles in a desired fluid.

### CROSS REFERENCE TO RELATED U.S. PATENT APPLICATIONS

This patent application claims the priority benefit from U.S. Provisional Patent Application Ser. No. 60/567,778 filed on May 5, 2004 entitled SURFACE PASSIVATION OF NANOPARTICLES THROUGH A LIGAND EXCHANGE PROCESS, and which is incorporated herein in its entirety.

### FIELD OF INVENTION

This invention relates to a method of surface modification of colloidal quantum nanoparticles using polymer multidentate ligands for stabilizing quantum size-dependent properties of nanocrystals and providing colloidal stability of the nanoparticles in solvents.

### BACKGROUND OF THE INVENTION

Nanocrystals (NCs) of semiconductor materials, including so-called quantum dots (QD), have been attracting a broad range of attention from a variety of disciplines owing to their novel optical, electrical and catalytic properties.¹ The processibility of colloidal nanocrystals is exploited in a diversity of applications by tuning their organic surface characteristics. For example, a water-soluble surface is required for biological labels;² an electron conductive layer is important for solar cells;³ and a polymerizable surface is needed to make photoluminescence (PL) polymer composites.⁴

NCs are commonly prepared by an organometallic route in the presence of excess trioctylphosphine oxide (TOPO). The TOPO ligand passivates the NC surface and leads to particles with a high luminescence quantum yield (QY). However, this hydrophobic TOPO layer is often neither suitable nor robust enough for many applications. Moreover, these monodentate ligands are labile and in dynamic equilibrium with the surrounding medium. As the surface passivation is disrupted, the photoluminescence QY diminishes. Furthermore, when TOPO is removed from the colloidal NC solution, the particles become unstable and begin to aggregate.

Polymers can be envisaged as versatile surface modifiers because of their processibility and tunable functionality. In practice, two main methods have been used to modify NCs with polymers: i) Encapsulation of NCs including their original ligands with polymers through ionic or hydrophobic interaction⁵ and ii) surface grafting through living polymerization.⁶ Surface grafting, unfortunately, usually results in a diminished photoluminescence QY relative to the original NCs. Polymer encapsulation can preserve the QY, but generally leads to composite structures containing many NC particles, rather than single encapsulated particles.⁷ This type of encapsulation can generate a thick organic outer layer that is often undesirable.

An alternative strategy for manipulating NC surfaces involves ligand exchange. In the past, most of the examples involved replacing TOPO with another monodentate ligand. Polydentate ligands provide enhanced coordination interactions due to a cooperative, amplifying effect of multiple binding sites. Bawendi and co-workers recently developed a multidentate oligomeric alkyl phosphine ligand to passivate NCs,⁸ leading to a thin and stable organic shell. That work established a proof of concept, but required an elaborate synthesis of the phosphine oligomers.

Fogg et al.¹³ described the synthesis of norbornene-based block copolymers that would be able to incorporate and confine quantum dots (QDs) into microdomains within solid-state polymer matrices. The authors envisioned that the photoelectronic properties of uniformly dispersed nanoclusters could be exploited to provide electronic devices within a conductive polymer matrix. The polymer synthesized by ring-opening metathesis polymerization (ROMP) had a complex and difficult-to-characterize backbone structure and one block that contained phosphine or phosphine oxide groups in the repeat unit. The main test for the cluster-sequestering ability of the polymers was resistance of the QD-containing bulk polymer to extraction of the unbound QDs with pentane. Electron microscopy measurements established that these polymers could indeed entrap the QDs within one type of microdomain.

When phosphine containing block copolymers were added to a solution in tetrahydrofuran (THF) of TOPO-passivated CdSE QDs, an increase in photoluminescence intensity was detected. The response was slow, and evolved over more than 20 h. The extent of increase corresponded to that found when trioctylphosphine was added to a similar solution, a result interpreted to mean that phosphine groups were able to passivate sites on the CdSe unavailable to the TOPO groups.

In a second publication¹⁴, this group describes a convergent approach to hybrid organic-inorganic composites in which nearly monodisperse CdSe or ZnS coated CdSe (CdSe/ZnS) NCs were sequestered within phosphine-containing domains in a charge transporting matrix. The authors comment that they used fluorometry to examine the passivating abilities of a range of potential donors for CdSe/ZnS nanoclusters. Screening experiments with TOPO, with triethyl amine and with an oxadiazole derivative denoted PBD indicated that these potential donors all led to a decrease in emission intensity. As a consequence, only phosphine-containing polymers were used as suitable hosts for CdSe/ZnS clusters.

Therefore there is a pressing need to learn how to modify the surface of NCs with polymers bearing ligands other than simple phosphines, not only to obtain a diversity of surface characteristics, but also to provide colloidal stability to NC solutions.

### SUMMARY OF INVENTION

The present invention provides a method of modifying nanoparticles, such as but not limited to luminescent colloidal nanocrystals and quantum dots, using a ligand exchange process involving homopolymers and/or copolymers bearing the liganding groups.

Nanocrystals (NCs) of semiconductor materials, including so-called quantum dots (QD), have been attracting a broad range of attention from a variety of disciplines owing to their novel optical, electrical and catalytic properties. The inventors have developed a ligand exchange method to modify NCs with a polymer having functional groups, which can bind to the surface of the nanocrystal. This method establishes the utility of using simple homopolymers or copolymers, which can be synthesized in a controlled manner, as robust multidentate ligands for NC surface modification.

These polymers provide colloidal stability as well as stabilizing quantum size-dependent properties of the nanocrystals. The invention disclosed herein provides new strategies for introducing functional groups on the particle surface without sacrificing any of the attractive features provided by homopolymer adsorption. The processibility conferred upon NCs by the bound polymer could exploited in a diversity of applications, for example, a water-soluble surface is required for biological labels; an electron conductive layer is important for solar cells; and a polymerizable surface is needed to make photoluminescence (PL) polymer composites (e.g. for lasers). In a specific non-limiting example, the passivation of CdSe/ZnS (core/shell) quantum dots using an amine-containing polymer, polydimethylaminoethylmethacrylate (PDMAEMA) that acts as a multidentate ligand is demonstrated.

In another example, treating a colloidal solution of CdSe NCs in chloroform with a copolymer of methyl methacrylate (MMA) and ureido methacrylate (UreMA) led to ligand exchange and binding of the polymer to the NC surface. The particles obtained in this way formed strongly luminescent colloidal solutions in acetonitrile. Poly(methyl methacrylate) (PMMA) and many of its copolymers are soluble in this polar solvent, whereas the original TOPO-covered CdSe NCs cannot form colloidal solutions in acetonitrile.

The present invention provides a method of stabilizing quantum size-dependent properties of nanocrystals and providing colloidal stability of the nanoparticles in a desired liquid, comprising:

preparing a colloidal dispersion of nanoparticles in a liquid;

preparing a suitable polymer multidentate ligand and dissolving said suitable polymer multidentate ligand in a fluid, the polymer multidentate ligand having first portions which can bind to a surface of the nanoparticles and a second portion which does not bind to the surface of the nanoparticles;

mixing the fluid containing the suitable polymer with the colloidal dispersion of nanoparticles under conditions suitable to induce binding of at least some of the first portions of the polymer multidentate ligand onto the surface of the nanoparticles, the suitable polymer multidentate ligand being selected so that the at least some of the first portions which bind to the surface to stabilize quantum size-dependent properties of the nanocrystals, and the second portion which does not bind to the surface provides colloidal stability of the nanoparticles in a desired liquid.

The quantum nanoparticles may be semiconductor quantum nanoparticles.

The present invention also provides a dispersion of nanocrystals comprising a plurality of nanocrystal particles in a desired dispersion liquid, a suitable polymer multidentate ligand having first portions bound to a surface of the nanoparticles and a second portion which does not bind to the surface of the nanoparticles, the suitable polymer multidentate ligand being selected so that the first portions which bind to the surface stabilize quantum size-dependent properties of the nanocrystals, and the second portion which does not bind to the surface provides colloidal stability of the nanoparticles in the desired dispersion fluid.

### BRIEF DESCRIPTION OF DRAWINGS

The following is a description, by way of example only, of the method of surface passivation of luminescent colloidal quantum dots using a ligand exchange process in accordance with the present invention, reference being had to the accompanying drawings, in which:

FIG. 1 shows TEM images of NCs (a) on the left hand side in the absence and (b) on the right hand side in the presence of PDMAEMA, scale bar=20 nm; this PDMAEMA sample was prepared by ATRP;

FIG. 2 shows CONTIN plots of the Rₕ of NCs in toluene (a) in the absence and (b) in the presence of PDMAEMA homopolymer, revealing that the hydrodynamic radii of the particles increases when the TOPO is exchanged on the surface for the polymer; this PDMAEMA sample was prepared by controlled radical polymerization (ATRP);

FIG. 3 shows ³¹P NMR of NCs in the presence of PDMAEMA with triphenylphosphine as an internal reference, showing that TOPO is released from the NC surface in the presence of PDMAEA;

FIG. 4A shows photoluminescence intensity of NCs before and after surface modification with PDMAEMA;

FIG. 4B shows UV-Vis and fluorescence (FL, excited at 475 nm) spectra for PDMAEMA modified NCs;

FIG. 5 shows a drawing indicating the surface adsorption of a polymer like PDMAEMA onto the surface of a quantum dot accompanied by the replacement of TOPO groups initially bound to the particle; and

FIG. 6 shows CONTIN plots of Rₕ of CdSe NCs (a) before and (b-e) after addition of (b) M_{7K}-, (c) M_{10K}-, (d) M_{15K}-, and (e) M_{35K}-PDMAEMA in toluene, these PDMAEMA samples were prepared by traditional solution free radical polymerization.

### DETAILED DESCRIPTION OF THE INVENTION

Definitions

We define nanocrystals (NCs) as any inorganic crystalline material of any shape that has dimensions between about 1 and about 500 nm. Alternative names include microcrystallites and nanoclusters. Typically these materials are colloidal, in that they can be dispersed in a solvent to form a colloidal solution, but we do not limit ourselves to the case of exclusively colloidal materials. For example, we envisage that rod and wire shaped nanocrystalline materials can be passivated as we describe, so that we include such materials in the definition of NCs.

We define nanoparticles more broadly as any inorganic material, not necessarily crystalline, of any shape that has dimensions between about 1 and about 500 nm. Thus nanocrystals are a subset of nanoparticles.

The terms quantum dots or quantum nanocrystals are also used herein and these are nanoparticles which are small enough that they exhibit quantum size effects, and hence are also a subset of the class of materials comprised of nanoparticles. We include in this definition any shape of crystal, including, but not limited to, nanorods, nanowires, teardrops, tetrapods, etc. Typically these nanoparticles have an average diameter in the range 1.2 nm to 50 nm which exhibit properties including one or more of the spacing of energy levels, the optical gap, the band gap, magnetic properties, the wavelength of maximum photoluminescence, plasmon resonance, that are size-tuneable and/or shape tuneable.

At the surface of a nanocrystal, bonds are said to be ‘dangling’ because the crystal unit cell is not infinitely repeating. Often these ‘dangling bonds’ destabilize the nanocrystal through their tendency to form surface trap states and, in the case of luminescent nanocrystals, quench photoluminescence.

As used herein, the term “passivation” is the process whereby molecules bond or coordinate to these dangling bonds on the surface of any nanocrystal.

We refer to any molecule that is capable of passivating a nanocrystal surface as a “ligand”. For a large or complex molecule, in which a functional group attached to the molecule binds to the surface of the nanocrystal and passivates it, we refer to the functional group itself as the ligand. In traditional terms, a molecule that contributes two such functional groups to surface passivation is a bidentate ligand, and a molecule that contributes three or more such functional groups is a multidentate ligand.

As used herein, the term “polymer multidentate ligand” (PML) or “polymer as a multidentate ligand” means a polymer or copolymer containing about 10 or more repeat units in total, including 3 or more repeat units that are suitable ligands for binding to nanoparticles such that the polymer acts as a multidentate ligand in its binding to the nanoparticle surface.

We also include under this definition, the situation in which two, three, or more functional groups are part of a given pendant group. Thus a pendant group, which is repeated along the polymer chain, can contain a traditional multidentate ligand. When a nanoparticle has been passivated, we describe it as “packaged”.

“Colloidal stability” is indicated by a dispersion of nanoparticles in a fluid in which the system as a whole (i.e., the majority of the dispersed nanoparticles) does not coagulate or precipitate over a period of three days or more.

It is note that in some scientific communities, these types of colloidal dispersions are sometimes referred to as “colloidal suspensions.” We use both terms interchangeably.

It will be understood that if the polymer is too long, it will cause the nanoparticles to precipitate (i.e., it will act as a flocculent. Therefore, the polymer multidentate ligand preferably has at most from about 10 to about 2500 repeat units, more preferably from 10 to 1000, and most preferably from 10 to 250.

When we use the phrase “stabilizing quantum size-dependent properties of the nanocrystals” we mean: minimizing the presence or introduction of surface impurities and/or trap states that modify the spectral properties of the absorption or photoluminescence spectrum in its shape, intensity, band positions, or any other desirable feature, and/or detrimentally affecting the yield of photoluminescence, and/or degrading desirable magnetic properties, and/or electrical properties, including, but not limited to, conductivity of charge to and from the nanocrystals. It will be understood that while some of these properties, for example the yield of photoluminescence may be somewhat reduced upon modification of the nanocrystals according to the present invention, they nonetheless remain stabilized over periods of time much longer than the non-modified nanocrystals.

A nanoparticle is deemed to be “packaged” when one or more PMLs are adsorbed on its surface.

“Ure” refers to the ureido group, as in ureido methacrylate (UreMA).

“ATRP” refers to atom transfer radical polymerization, a type of living/controlled radical polymerization.

When we refer to a polymer or homopolymer in which a suitable functionality has been introduced as a pendant group in repeat units of the polymer, the phrase “suitable functionality” means a substituent that can act as a ligand toward a nanocrystal.

As used herein, the phrase “a polymer having multidentate ligands” means a macromolecule containing repeating units that are capable of passivating a nanocrystal surface. These repeating units may be identical (homopolymer), or there may be different kinds (usually two or three) that repeat either randomly (random copolymer) or non-randomly, or they may repeat in blocks (block copolymer). Repeat units with oligomeric or polymeric pendant groups are commonly thought of as being “grafted” to the main polymer backbone, and the resulting polymer is known as a “graft copolymer. The inventors define a repeat unit (RU) to be the fundamental building block of the polymer backbone, and they define a pendant group as the portion of the repeat unit that protrudes from the polymer backbone.

One kind (at least) of RU has chemical functionality, such that it acts as a ligand, and coordinates, or bonds in some manner, directly to the surface of the nanoparticle, thus acting to passivate the nanoparticle. Because there are more than one of these repeat units, the polymer acts as a multidentate ligand. The present invention is exemplified using a RU in which the pendant group is functionalized with an amine ligand and with another example in which a fraction of the pendant groups are functionalized with a ureido group.

In the case of a copolymer, the RUs that do not coordinate to the nanoparticle may incorporate other chemical functionality that confers desirable properties to the “packaged” nanoparticle. For example they may improve solubility in various solvents, or may improve processibility. They may have functional aspects too, e.g. they may provide an improved interface with surrounding material in order to improve the performance/efficiency of a device such as a solar cell, or they may be used to tune absorption of light or photoluminescence.

The present invention provides a method of surface passivation of luminescent colloidal quantum dots using a ligand exchange process. In a non-limiting example, the present invention provides a process for the passivation of CdSe/ZnS quantum dots using an amine-containing polymer, polydimethylaminoethylmethacrylate (PDMAEMA) that acts as a multidentate ligand. In another example, the present invention provides a process for the passivation of CdSe quantum dots using a P(MMA-co-Ure) copolymer of Mₙ=5,000 and M_{w}/Mₙ=2.2 containing 13 mol % Ure groups. Ureido monomers, which are allylic and acrylic derivatives of hydroxyethylethyleneurea and aminoethylethyleneurea, have been widely used as comonomers in coatings and paints industry in order to improve adhesion properties to ionic surfaces, especially metals, through electrostatic charge interaction ¹⁵. 2-(2-Oxo-1-imidazolidinyl)ethyl methacrylate (UreMA) is commercially available.

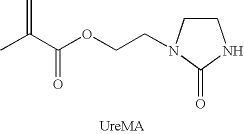

The unique optical characteristics of the CdSe nanoparticles appeared to be retained after surface modification with P(UreMA-MMA) random copolymers. In experiments with different solvents including chloroform, acetonitrile, and mixed solvents of chloroform/MeOH (3/1 wt ratio), the absorption peak remained constant at 483 nm. And for samples of identical absorbance at this wavelength, we found that the retention of PL intensity for P(UreMA-MMA)-capped CdSe is 89% in chloroform, 67% in acetonitrile, and 27% in mixed solvents of chloroform/MeOH (3/1 wt ratio).

Conventional homopolymers can be thought of as multidentate ligands if a suitable functionality can be introduced as a part of the pendant group in the repeat unit. For example, PDMAEMA contains a tertiary amine in the repeat unit, as shown below in Example 1. The synthesis of well-defined samples of PDMAEMA has been greatly simplified as a result of recent advances in living polymerizations.⁹ The inventors disclose herein a facile modification of the surface of TOPO-coated NCs using PDMAEMA homopolymer as a multidentate ligand. We show that the polymer replaces TOPO groups on the nanoparticles. The modified NCs form colloidally stable solutions in TOPO-free hydrophobic solvents such as toluene. They also form stable solutions in protic solvents such as methanol.

The present invention will be illustrated by the following non-limiting examples.

### EXAMPLE 1

### Synthesis of PDMAEMA By Controlled Radical Polymerization (ATRP)

To a reaction flask, methyl 2-bromopropionate (173 mg, 1.0 mmol), dimethylaminoethylmethacrylate (4.5 g, 28.6 mmol), and water/isopropanol (1:1 by volume) were added. The water/isopropanol solution was degassed through one freeze-thaw cycle. Then the copper catalyst complex (cuprous chloride/bipyridine (1:2)) was added to start the polymerization. After 4 h at 22° C., the solution was cooled to room temperature, diluted by adding THF, and passed through a silica column to remove the blue copper catalyst. A white gum-like product was obtained after removing solvent and drying overnight at 50° C. in a vacuum oven. The polymer was characterized by gel permeation chromatography (GPC) using polystyrene standards, and shown to have a number-averaged degree of polymerization of 30 and a polydispersity index (PDI) of 1.3.

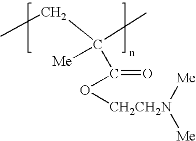

### EXAMPLE 2

### Synthesis of CdSe/ZnS

For CdSe/ZnS core-shell synthesis, all chemicals used in this synthesis were purchased from Aldrich, except for dimethyl cadmium and dimethyl zinc, which were purchased from Strem. Trioctylphosphine oxide (TOPO, 7.5 g) was dried and degassed by heating under vacuum to 150° C. for 30 min. The temperature was then raised to 320° C. under approximately 1 atm of Ar. Once the temperature had stabilized, a solution of Cd/Se/TOP (TOP: trioctylphosphine), prepared by mixing 45 μL of dimethylcadmium, 1 mL of 1M Se in TOP and 4 mL of TOP, was injected rapidly into the reaction flask, and the heat was removed. The reaction mixture was allowed to cool to 240° C., then a small aliquot was extracted for characterization of the initial CdSe nanocrystals. The nanocrystals were grown at 240° C. to the desired size. Excess methanol was then added to the synthesized CdSe (in toluene) to precipitate the nanocrystals and remove the excess phosphine ligands. The nanocrystals were re-dispersed in toluene and then isolated by precipitating again with methanol. The nanocrystals were dried using a stream of nitrogen gas. 35 mg of the dried nanocrystal powder were then dispersed in 0.5 mL toluene and were injected at 60° C. into a previously dried and degassed 5 g TOPO. The toluene was pumped off at 60° C., after which the temperature was raised to 180° C. At this temperature, a solution of Zn/S/TOP prepared by mixing 155 μL diethylzinc, 310 μL trimethyidisilathiane and 4 mL TOP was injected dropwise at 10 s intervals. The reaction was cooled to 100° C. and stirred for 1 h.

### EXAMPLE 3

### Synthesis of PDMAEMA By Conventional Free Radical Polymerization

A series of samples of PDMAEMA were synthesized by conventional batch solution polymerization of DMAEMA in toluene at 95° C., initiated with , 2,2-azobis (2-methylbutyronitrile (AMBN, VAZO V-59). Dodecanethiol (C₁₂—SH) was introduced to control molar mass. As a typical example, the recipe for the synthesis of a sample (M_{7K}-PDMAEMA) is summarized in Table 1. The specific procedure is described below: In a 100 mL of three-neck round-bottom flask provided with a magnetic stirrer and condenser, DMEAMA (20 g), AMBN (0.2 g, 1 wt % of DMAEMA), and C₁₂—SH(0.46 mL, 2 wt % of DMAEMA) were dissolved in toluene (24 g) to form a homogeneous clear solution. The flask was capped with rubber septa, and then the flask was immersed into an oil bath pre-heated to 95° C. The polymerization reaction was run under an N₂ atmosphere. It was maintained at 95° C. for 2.5 h, and then cooled to room temperature. This reaction produced a solution of M_{7K}-PDMAEMA with 45.1 wt % solids content. In a similar way with different amounts of C₁₂—SH, a series of samples of PDMAEMA at different molar mass were prepared. These polymers were precipitated in hexane by adding the polymer solution into hexane under magnetic stirring, and then dried at 45° C. for 4 h in a vacuum oven. The polymer molecular weights were determined by GPC, and the characteristics of these polymers are listed in Table 2.

### EXAMPLE 4

### Ligand Exchange of CdSe QDs With PDMAEMA Prepared By Free Radical Polymerization

To modify the surface of CdSe NCs with poly(DMAEMA), an aliquot of the polymer in an organic solvent such as THF, chloroform or deuterobenzene (for NMR monitoring) was added to the purified TOPO-capped NCs dissolved in the same organic solvent. In a typical example, an aliquot of dried M_{7K}-PDMAEMA (45 mg) was added into the purified TOPO-capped CdSe (7.9 mg) dissolved in C₆D₆(1.5 g), and then stirred at room temperature overnight. The resulting solution was optically transparent, highly luminescent and homogenous. Evidence obtained by ¹H and ³¹P NMR indicated that TOPO on the surface of the QDs had been released into solution.

The modified NCs form stable colloidal solutions in TOPO-free hydrophobic solvents such as toluene. They also form stable colloidal solutions in protic solvents such as methanol.

### EXAMPLE 5

### Ligand Exchange Followed By Modification For the Preparation of Water Dispersible CdSE QDs

An experiment identical to that described in Example 4 was carried out using toluene as the solvent. The resulting solution remained highly fluorescent. When this solution was floated on top of 2 mL of water in a beaker containing a magnetic stirring bar, the lower aqueous layer was clear, and the luminescent material was confined to the upper, organic phase. Addition to the solution under gentle magnetic stirring of 1 equivalent of methyl tosylate (based on total amino groups supplied by the polymer) led to a profound change in the system. The fluorescent color moved from the toluene phase to the aqueous phase. The aqueous phase was separated using a separatory funnel, and remained highly fluorescent for the several days that the solution was monitored.

### EXAMPLE 6

### Synthesis of Poly(methyl methacrylate-co-ureidoethyl methacrylate) (P(MMA-UreMA))

A copolymer of UreMA with MMA, P(UreMA-MMA), was synthesized by conventional solution polymerization using a mixture of monomers (UreMA and MMA) in a 1/3 wt ratio, dissolved in a mixture of solvent of methylethyl ketone (MEK) plus isopropyl alcohol (IPA) (4/1 wt ratio). The reaction was run at 85° C., initiated with an azo-type initiator) (AMBN, V-59) and 1-Dodecanethiol (C₁₂—SH, 2 wt % of monomers) as chain transfer agent. This reaction produced a transparent solution of P(UreMA-MMA) with 34 wt % solids content and over 98 wt % monomer conversion. The dried copolymer had Mₙ=5,000 and M_{w}/Mₙ=2.1, determined by GPC with polystyrene standards. The amount of UreMA in the copolymer was found to be 13 mol % by ¹H-NMR in DMSO-d₆. NMR measurements as a function of polymer conversion established that the Ure groups were essentially randomly distributed along the polymer backbone. The copolymer appeared to have limited solubility in nonpolar solvents such as toluene; however it appeared to be soluble in polar solvents such as tetrahydrofuran (THF), CHCl₃, and DMSO.

### EXAMPLE 7

### Ligand Exchange of CdSe QDs and CdSe/ZnS QDs with PDMAEMA

The inventors synthesized PDMAEMA both through conventional and living free radical polymerization. For both sets of reactions, the degree of polymerization (DP) and polydispersity index (PDI) are well controlled, the latter conditions providing polymer of a much narrower PDI. High quality CdSe quantum dots and CdSe/ZnS core-shell colloidal quantum dots were prepared using established procedures.¹⁰ In this study, PDMAEMA with a degree of polymerization of 30 and PDI of 1.3 is shown to displace TOPO ligands on CdSe/ZnS (core/shell) NCs after mixing the polymer with a dilute colloidal solution of NCs in toluene at room temperature. The colloidal NC solutions before and after addition of the polymer were characterized by dynamic light scattering, which provided the hydrodynamic radius, Rₕ, of the particles. As shown in the CONTIN plot in FIG. 2 for the case of the PDMAEMA sample prepared by controlled radical polymerization, there is a clear shift of Rₕ from ca. 3.0 nm to 5.9 nm, suggesting a layer of polymer has been deposited on the particle surface. While the peak at higher radius is broader than that of the original particles, this is not an indication of particle aggregation, as shown by TEM.

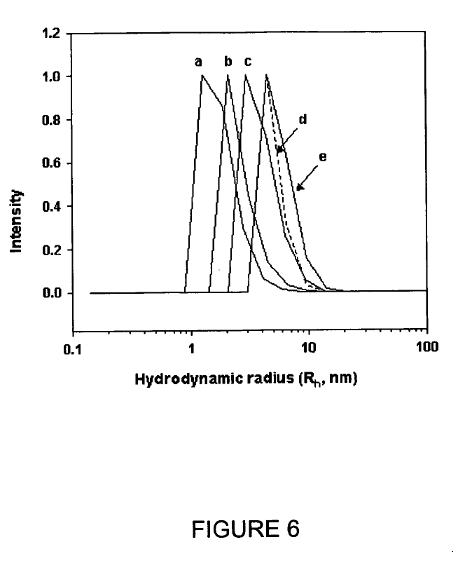

Similar data were also obtained for each of the samples of PDMEAMA prepared by conventional solution free radical polymerization (see Table 2). CONTIN plots for these samples are presented in FIG. 6.

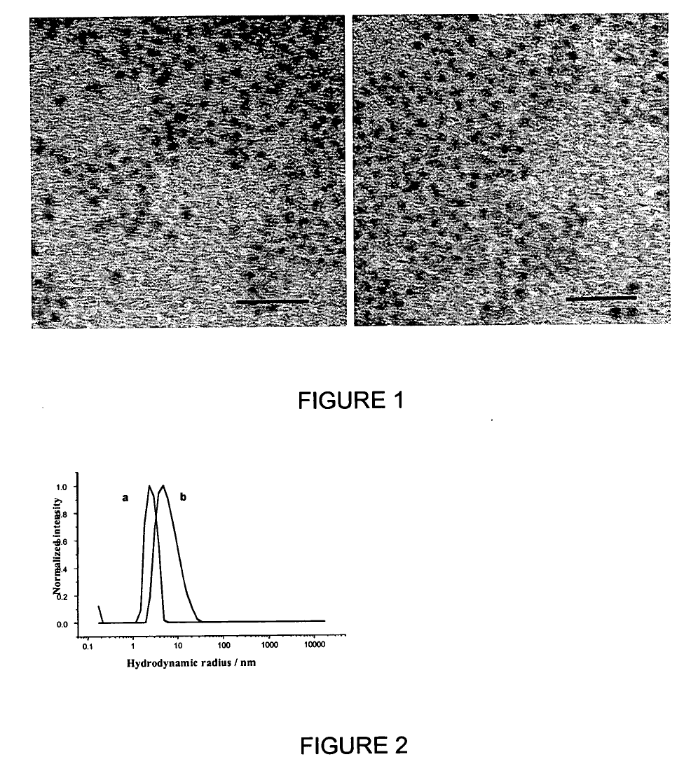

TEM samples were prepared by drying a drop of NC solution onto carbon coated copper grids. TEM experiments (FIG. 1) show that the diameters of the CdSe/ZnS NC particles before and after surface modification with PDAEMA are virtually identical, indicating that the particles remain discrete. The specific example shown in FIG. 1 is for the PDMAEMA sample prepared by controlled radical polymerization, but essentially identical results were obtained for each of the samples described in Table 2. Therefore, the observed increase in particle size by DLS measurement can be attributed to the adsorption of a polymer layer on the NCs.

The NMR experiments described above suggest that at least some of the TOPO ligand on the particle surface is released to the solution when the particles are exposed to the polymer. In order to address this question in more detail, we carried out further ³¹P NMR measurements of the NCs in CDCl₃. According to Bawendi,¹¹ high-resolution ³¹P NMR measurements of TOPO-capped CdSe quantum dots in solution usually exhibit several broad signals associated with the bound TOPO ligand. The complexity of the NMR signal suggests that a variety of phosphorus chemical environments are available to TOPO ligands bound to the NC surface, which may include bound dimers of TOPO.¹²

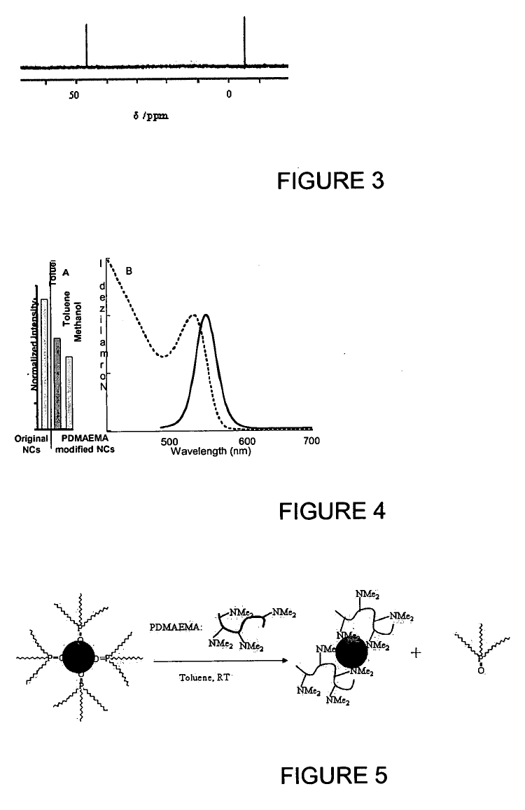

In our experiments on CdSe/ZnS NCs in a CDCl₃ solution (ca. 30 mg/5 ml) in the absence of PDMAEMA, we did not observe any ³¹P signals, presumably due to the low concentration of the nanoparticles. However, when a sample of PDMAEMA (50 mg) from Example 1 was added, a sharp ³¹P signal appeared at 47 ppm (FIG. 3), which corresponds to free TOPO ligand in CDCl₃.¹¹ This result emphasizes the fact that ligand replacement occurred. We were able to quantify the amount of TOPO released by carrying out the ³¹P NMR experiment in the presence of a known amount of triphenylphosphine as an internal standard (peak at −5 ppm). In this way, we determined that approximately 10 mg TOPO (26 μmol) was released from the 30 mg of NCs present in the solution.

Surface modification of the CdSe/ZnS NCs with PDMAEMA had only a modest effect on the photoluminescent QY of the particles. In FIG. 4 we compare the luminescent intensity of NCs in toluene, before and after addition of the polymer. The small (ca. 30%) drop in luminescence intensity was rapid upon polymer addition, and the QY of the toluene solution appeared to remain stable for at least 3 days thereafter.

As a result of this polymer modification, the NCs become miscible with protic solvents, such as methanol. To transfer the polymer-capped NCs to methanol, methanol was simply added to the solid remaining after evaporation of toluene. The resulting solution appeared to be homogeneous and, when excited at 475 nm, displayed a strong photoluminescence peaked at 545 nm, close to the emission peak of the original sample (544 nm), suggesting that there is no significant agglomeration of NCs upon solvent change. We also obtained a similar result by directly adding methanol to the solution of polymer modified NCs in toluene.

### EXAMPLE 8

### Ligand Exchange of CdSe QDs with P(MMA-UreMA)

An aliquot of the P(MMA-UreMA) polymer described in Example 6, with Mₙ=5,000 and M_{w}/Mₙ=2.1, dissolved in chloroform was added to a solution of 2.0 mg of purified CdSe/TOPO in 2 mL of chloroform. The solution was stirred overnight. A CONTIN plot of the dynamic light scattering data (see FIG. 6) showed that the apparent hydrodynamic radius of the particles increased from 3 nm before addition of the polymer to 7 nm after exposure to the polymers. The solution remained brightly luminescent with no change in absorption or emission maxima. ³¹P-NMR experiments confirm release of TOPO from the QD surface into the solution. When the solvent was evaporated, the remaining solid gave a brightly luminescent solution when acetonitrile was added to the flask. The original CdSe/TOPO will not dissolve in acetonitrile. These results indicate that the P(MMA-UreMA) becomes tightly bound to the QD surface.

Similar experiments were carried out on CdSe NCs in chloroform using a P(MMA-co-UreMA) copolymer with a mean degree of polymerization of ca. 50 and 13 mol % Ure groups. Dynamic light scattering measurements also showed an increase in hydrodynamic radius in solution with no obvious change in particle size as seen in TEM images.

In conclusion, the inventors have developed a method to modify NCs with polymer multidentate ligands which have been shown herein to stabilize quantum size-dependent properties of the nanocrystals and provide colloidal stability of the nanoparticles in solvents. In a non-limiting example, an amine-containing polymer, PDMAEMA, was used as the multidentate ligand which led to NCs securely bound by a layer of a “conventional” homopolymer, as diagrammed in FIG. 5. The modified NCs retain 70% of their original photoluminescence quantum yield. As a result of this surface modification, the NCs become soluble in polar media, such as methanol. This method establishes the utility of using simple homopolymers, which can be synthesized in a controlled manner, as robust multidentate ligands for NC surface modification. These polymers provide colloidal stability as well as surface passivation. The extension of this work to copolymers is straight forward, opening the door to new strategies for introducing functional groups on the particle surface without sacrificing any of the attractive features provided by homopolymer adsorption.

It will be understood by those skilled in the art that many different functional groups can bind to the surface of nanocrystals, and that these functional groups can be incorporated as pendant groups or as substituents of pendant groups the polymer. The specific choice of functional groups is based upon knowledge of the types of functional groups attached to small molecules that bind to the surface of nanocrystals. The inventors contemplate that for nanocrystals that bind TOPO, functional groups suitable for the polymer chain include aliphatic amines (primary, secondary, tertiary), oximes, aromatic amines including pyridines, imidazole derivatives, pyrazine, phosphines and phosphine oxides, phosphates, phosphonates, furans, acetoacetyl groups, ureido groups, fatty acids, Lewis acids such as trialkylborane and trialkylaluminum, and sulfur containing substituents such as thiols, disulfides and xanthate esters. The inventors contemplate that related functional groups that include alternative elements from groups VA and VIA are also suitable as ligand groups for the polymer chain.

It will be understood by those skilled in the art that while PDMAEMA provides many dimethylamino groups that bind to the surface of the nanocrystals (and hence is a multidentate ligand), all of its copolymers with say from about 10% to 99.99% dimethylaminoethyl pendant groups will also serve as multidentate ligands. This includes copolymers with a broad variety of other monomers (acrylic and methacrylic esters such as ethyl acrylate, 2-ethylhexyl acrylate, and butyl acrylate, as well as methyl methacrylate, butyl methacrylate, and 2-ethylhexyl methacrylate; vinyl aromatic monomers such as styrene, alpha-methyl styrene, vinyl toluene, vinyl pyridine, para-acetoxy styrene as well as nitriles such as acrylonitrile and amides such as vinyl pyrrolidone, acrylamide, N-alkyl acrylamides and methacrylamides, N,N-dialkyl acrylamides.

Other copolymerizable monomers which can be used in this invention are derivatives of the hypothetical vinyl alcohol, i.e., aliphatic vinyl esters such as vinyl formate, vinyl acetate, vinyl propionate, vinyl butyrate, vinyl 3,6,9-trioxaundecanoate, the vinyl esters of versatic acid (sold under the trade name Veova 10™, vinyl esters of neo acids and the like.

Ligands which are particularly suitable for use in passivating some NCs, for example PbS, are those containing carboxylic acids since the carboxylic acid groups have shown affinity for the these nanocrystalline materials. Thus, acrylic acid, methacrylic acid, vinylbenzoic acid are monomers that can be used to introduce these groups into copolymers.

In addition, a variety of amine-containing polymers such as poly(ethylene imine) and poly(vinyl amine), as well as derivatives of these polymers bearing aromatic groups, aliphatic hydrocarbon chains, or fluorocarbon chains can act as multidentate ligands.

Other polymers that can act as multidentate ligands for nanocrystals are block copolymers and graft copolymers in which the polymer comprising one or more of the blocks or grafts is chosen to promote the solubility or colloidal dispersability of the nanocrystals in different media. For example, a diblock copolymer with a ligand containing block and fluorine rich block will promote the dispersion of nanocrystals in fluorocarbon media. Similarly, a graft copolymer bearing either a fluorocarbon backbone and ligand-containing chains as grafts, or with a ligand-containing backbone and fluorocarbon chains as grafts, will promote the dispersion of nanocrystals in fluorocarbon media. These types of polymers as well as polymers in which the non-ligand containing block or graft is a siloxane polymer, will promote the dispersion of nanocrystals in liquid or supercritical carbon dioxide.

Block and graft copolymers with a water-soluble block or graft, such as poly(ethylene glycol), polydimethylacrylamide, or poly(acrylic acid), in addition to a ligand-containing portion, will act as a multidentate ligand for the nanocrystals and promote the dispersion of nanocrystals in polar solvents such as alcohols and in aqueous media.

Similarly, while the present invention has been exemplified using semiconducting CdSe and CdSe/ZnS quantum nanoparticles, it will be appreciated that the present invention will apply to all nanoparticles regardless of composition including all nanocrystals, both semiconducting and non-semiconducting. Examples of non-limiting semiconductor materials include silicon, germanium, indium phosphide, gallium arsenide, cadmium teluride, lead sulfide, lead selenide, zinc selenide, zinc sulfide, cadmium sulfide, silver sulfide, copper sulfide, zinc oxide, titanium dioxide but for which the choice of the polymer pendant group will have to be chosen in a way that reflects its interactions with the surface of the nanocrystal. Those skilled in the art will appreciate that they can readily select what functional groups will adhere to various inorganic surfaces.

Based on the present invention that polymers, including homopolymers and copolymers, with appropriately designed pendant groups can act as multidentate ligands to passivate the surface of quantum dots, and at the same time promote compatibility with different media, this invention may be used for many useful applications. For example, this invention may be used to facilitate solution-based manufacturing processes, for example for inks and coatings, based upon semiconductor quantum dots.

Commercial applications for which the present invention may be used include, but are not limited to, print security markings and barcodes that absorb and/or emit light at near-infrared wavelengths. For example, CdTe, PbS, PbSe, InP, GaAs, or other suitable colloidal quantum dots can be surface-passivated by polymers that provide, in addition to the functional groups that passivate the quantum dot surface, pendant groups or polymer chains extending from the quantum dot corona that are specifically designed to bind to cellulose-based materials thereby forming a near-IR quantum dot ink.

The present invention may also be used to print security markings and barcodes that absorb and/or emit light at ultraviolet and/or visible wavelengths. For example, ZnSe, ZnS, CdS, CdSe, CdTe, ZnTe, or other suitable colloidal quantum dots can be surface-passivated by polymers that provide, in addition to the functional groups that passivate the quantum dot surface, pendant groups or polymer chains extending from the quantum dot corona that are specifically designed to bind to cellulose-based materials to give an ultraviolet-visible quantum dot ink.

To apply quantum dots to surfaces for the purpose of coating, imprinting information or markings of any sort, or painting, involves formulating latex-quantum dots blends as well as polyurethanes containing appropriately polymer-modified quantum dots, that will securely bind polymer-modified quantum dots to metal, plastic, and other surfaces to produce a quantum dot paint.

The quantum dots, once passivated according to the present invention may be combined with organic or inorganic-based fluorophores of any other type, and the mixture processed to induce binding of the desired fluorophore to the polymer that passivates the quantum dots.

The present invention may be used in any application where solution-based processing of quantum dots is facilitated by changing the solvent compatibility of the quantum dots by modifying their surfaces with adsorbed polymers. Thus optimal solvent choices can be made for a processing application and the quantum dots can be modified accordingly. The invention disclosed herein is useful for multilayer deposition, e.g. in devices based on organic polymers where one or more layers contains quantum dots or for any application where layers are deposited by ink jet printing.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

TABLE 1
The Recipe for the Synthesis of Poly(DMAEMA)
(M_{7K}-PDMAEMA) by Conventional Solution
Free-radical Polymerization of DMEAMA in Toluene ^{a}

| | | | |
|---|---|---|---|
| DMAEMA | 20 | g | |
| AMBN | 0.2 | g | 1 wt % based on DMEAMA |
| C₁₂—SH | 0.46 | mL | 2 wt % based on DMEAMA |
| Toluene | 24 | g | |

^{a} Solids content = 46 wt %.

TABLE 2
Characteristics of a Series of PDMAEMA Samples Synthesized by
Conventional Solution Free-radical Polymerization of DMEAMA.

| | M_{7K}- | M_{10K}- | M_{15K}- | M_{35K}- |
|---|---|---|---|---|
| | PDMAEMA | PDMAEMA | PDMAEMA | PDMAEMA |
| C₁₂—SH (wt %) ^{a} | 2 | 1 | 0 | — |
| Conversion (wt %) | 98 | 98.5 | 99 | — |
| Mₙ (g/mol) ^{b} | 7,100 | 10,000 | 15,000 | 35,000 |
| M_{w}/Mₙ ^{b} | 2.1 | 2.5 | 2.2 | 2.5 |
| Mₙ (g/mol) ^{c} | 5,000 | 6,600 | 11,700 | 28,000 |
| M_{w}/Mₙ ^{c} | 2.5 | 3.4 | 2.4 | 2.9 |

^{a} Wt % based on DMAEMA.

b. Determined by the GPC with polystyrene standard using NMP as an eluent.
c. Determined by the GPC with polystyrene standards using THF with Et₃N (2 vol %).

### REFERENCES

(1) Alivisatos, A. P. Science, 1996, 271, 933-937.
(2) Jovin, T. M. Nature Biotech. 2003, 21, 32-33.
(3) Huynh, W. U.; Dittmer, J. J.; Alivisatos, A. P. Science, 2002, 295, 2425-2427.
(4) a) Zhang, H.; Cui, Z. C.; Wang, Y.; Zhang, K.; Ji, X. L.; Lu, C. L.; Yang, B.; Gao, M. Y. Adv. Mater. 2003, 15, 777-780. b) O'Brien, P.; Cummins, S. S.; Darcy, D.; Dearden, A.; Masala, O.; Pickett, N. L.; Ryley, S.; Sutherland, A. J. Chem. Commun. 2003, 2532-2533.
(5) a) Potapova, I.; Mruk, R.; Prehl, S.; Zentel, R.; Basche, T.; Mews, A. J. Am. Chem. Soc., 2003, 125, 320-321. b) Cyr, P. W.; Tzolov, M.; Hines, M. A.; Manners, I.; Sargent, E. H.; Scholes, G. D. J. Mater. Chem. 2003, 13, 2213-2219.
(6) Farmer, S. C.; Patten, T. E. Chem. Mater., 2001, 13, 3920-3926. b) Skaff, H.; Ilker, M. F.; Coughlin, E. B.; Emrick, T. J. Am. Chem. Soc., 2002, 124, 5729-5733.
(7) Dubertret, B.; Skourides P.; Norris, D. J.; Noireaux, V.; Brivanlou, A. H.; Libchaber, A. Science, 2002, 298, 1759-1762.
(8) Kim S.; Bawendi, M. G. J. Am. Chem. Soc. 2003, 125, 14652-14653.
(9) Wang, X. S.; Armes, S. P. Macromolecules 2000, 33, 6640-6647.
(10) a) Murray, C. B.; Noms, D. J.; Bawendi, M. G. J. Am. Chem. Soc. 1993, 115, 8706-8715. b) Hines, M. A. and Guyot-Sionnest, P. J. Phys. Chem. 1996, 100, 468-471.
(11) Kuno, M.; Lee, J. K.; Dabbousi, B. O.; Mikulec, F. V.; Bawendi, M. G. J. Chem. Phys. 1997, 106, 9869-9882.
(12) Lorenz, J. K.; Ellis, A. B. J. Am. Chem. Soc. 1998, 120, 10970-10975.
(13) Fogg, D. E.; Radzilowski, L. H.; Blanski, R.; Schrock, R. R.; Thomas, E. L. Macromolecules 1997, 30, 417-426
(14) Fogg, D. E.; Radzilowski, L. H.; Dabbousi, B. O.; Schrock, R. R.; Thomas, E. L.; Bawendi, M. G. Macromolecules 1997, 30, 8433-8439

(15) Singh, B.; Chang, L. W.; DiLeone, R. R.; Siesel, D. R. Prog. Org. Coat. 1998, 34, 214

Therefore what is claimed is:

1. A method of stabilizing quantum size-dependent properties of nanocrystals and providing colloidal stability of the nanoparticles in a desired liquid, comprising:
preparing a colloidal dispersion of nanoparticles in a liquid;
preparing a suitable polymer multidentate ligand and dissolving said suitable polymer multidentate ligand in a fluid, the polymer multidentate ligand having first portions which can bind to a surface of the nanoparticles and a second portion which does not bind to the surface of the nanoparticles;
mixing the fluid containing the suitable polymer with the colloidal dispersion of nanoparticles under conditions suitable to induce binding of at least some of the first portions of the polymer multidentate ligand onto the surface of the nanoparticles, the suitable polymer multidentate ligand being selected so that the at least some of the first portions which bind to the surface to stabilize quantum size-dependent properties of the nanocrystals, and the second portion which does not bind to the surface provides colloidal stability of the nanoparticles in a desired liquid.

2. The method of modifying nanoparticles according to claim 1 wherein the polymer multidentate ligand is an amine-containing polymer.

3. The method of modifying nanoparticles according to claim 1 wherein the polymer multidentate ligand is a homopolymer having a pendent group that contains a primary, secondary, or tertiary amine.

4. The method of modifying nanoparticles according to claim 1 wherein the polymer multidentate ligand is a copolymer that contains 10 to 95 mol % of pendant groups with primary, secondary, and/or tertiary amine groups.

5. The method of modifying nanoparticles according to claim 1 wherein the polymer multidentate ligand is a homopolymer or copolymer having a pendant group that contains aromatic amine groups.

6. The method of modifying nanoparticles according to claim 5 in which the aromatic amine groups are selected from the group consisting pyridine, imidazole, pyrrole, pyrazine, and pyrazole units.

7. The method of modifying nanoparticles according to claim 1 wherein the polymer multidentate ligand is a copolymer containing metal binding ligands as pendant groups.

8. The method of modifying nanoparticles according to claim 7 wherein the metal binding ligands are selected from the group consisting of oxime and acetoacetate.

9. The method of modifying nanoparticles according to claim 1 wherein the polymer is synthesized by free radical polymerization.

10. The method of modifying nanoparticles according to claim 1 wherein the polymer multidentate ligand is synthesized by living/controlled radical polymerization.

11. The method of modifying nanoparticles according to claim 1 wherein the polymer multidentate ligand is synthesized by anionic or by cationic polymerization.

12. The method of modifying nanoparticles according to claim 1 wherein the polymer multidentate ligand is synthesized by group transfer polymerization.

13. The method of modifying nanoparticles according to claim 1 wherein the polymer multidentate ligand is polydimethylaminoethylmethacrylate (PDMAEMA).

14. The method of modifying nanoparticles according to claim 1 wherein the polymer multidentate ligand is a copolymer of dimethylaminoethylmethacrylate (DMAEMA) containing from about 10% to about 99.99% DMAEMA groups.

15. The method of modifying nanoparticles according to claim 1 wherein the polymer multidentate ligand is a copolymer containing ureidomethacrylate groups present in a range from about 5 mol % to about 40 mol %.

16. The method of modifying nanoparticles according to claim 15 wherein the ureidomethacrylate groups are present in a range from about 10 mol % to about 20 mol %.

17. The method of modifying nanoparticles according to claim 16 wherein the polymer multidentate ligand includes monomers selected from the group consisting of acrylic and methacrylic esters, vinyl aromatic monomers, nitriles, and amides.

18. The method of modifying nanoparticles according to claim 17 wherein the acrylic esters are selected from the group consisting of ethyl acrylate, 2-ethylhexyl acrylate, and butyl acrylate, and wherein the methacrylic esters are selected from the group consisting of methyl methacrylate, butyl methacrylate, and 2-ethylhexyl methacrylate, and wherein the vinyl aromatic monomers are selected from the group consisting of styrene, alpha-methyl styrene, vinyl toluene, vinyl pyridine and para-acetoxy styrene, and wherein the nitriles are selected from the group consisting of acrylonitriles, and wherein the amides are selected from the group consisting of vinyl pyrrolidone, acrylamide, N-alkyl acrylamides and methacrylamides and N,N-dialkyl acrylamides.

19. The method of modifying nanoparticles according to claim 1 wherein the polymer multidentate ligand is a homopolymer in which a suitable functionality has been introduced as a pendant group in repeat units of the polymer.

20. The method of modifying nanoparticles according to claim 1 wherein the polymer multidentate ligand is a copolymer in which a fraction of pendant groups bearing the suitable functionality ranges from 0.10 to 0.99.

21. The method of modifying nanoparticles according to claim 19 wherein the polymer multidentate ligand includes monomers selected from the group consisting of acrylic and methacrylic esters, vinyl aromatic monomers, nitriles, amides, and aliphatic vinyl esters.

22. The method of modifying nanoparticles according to claim 21 wherein the acrylic esters are selected from the group consisting of ethyl acrylate, 2-ethylhexyl acrylate, and butyl acrylate, and wherein the methacrylic esters are selected from the group consisting of methyl methacrylate, butyl methacrylate, and 2-ethylhexyl methacrylate, and wherein the vinyl aromatic monomers are selected from the group consisting of styrene, alpha-methyl styrene, vinyl toluene, vinyl pyridine and para-acetoxy styrene, and wherein the nitriles are selected from the group consisting of acrylonitriles, and wherein the amides are selected from the group consisting of vinyl pyrrolidone, acrylamide, N-alkyl acrylamides and methacrylamides and N,N-dialkyl acrylamides.

23. The method of modifying nanoparticles according to claim 21 wherein the aliphatic vinyl esters are selected from the group consisting of vinyl formate, vinyl acetate, vinyl propionate, vinyl butyrate, vinyl 3,6,9-trioxaundecanoate, the vinyl esters of versatic acid (sold under the trade name Veova 10™, vinyl esters of neo acids.

24. The method of modifying nanoparticles according to claim 1 wherein the polymer multidentate ligand is a block copolymer in which at least one block contains pendant groups bearing the suitable functionality and the second block does not. The non-functional block may be chosen from a wide variety of candidates including polystyrene, polybutadiene, polyisoprene, polydimethylsiloxane, polyacrylates including polyfluoroacrylates, polymethacrylates including polyfluoromethacrylates, polyethylene glycol, poly(acrylic acid) and polymethacylic acid.

25. The method of modifying nanoparticles according to claim 1 wherein the polymer multidentate ligand is a graft copolymer in which at least one of the graft chains contains pendant groups bearing the suitable functionality and the remaining portion of the polymer does not bear suitable functionality.

26. The method of modifying nanoparticles according to claim 25 wherein the portion of the polymer which does not bear suitable functionality is selected from the group consisting of polystyrene, polybutadiene, polyisoprene, polydimethylsiloxane, polyacrylates including polyfluoroacrylates, polymethacrylate including polyfluoromethacrylates, polyethylene glycol, methoxy- or alkoxy-terminated polyethylene glycol, poly(acrylic acid) and polymethacylic acid.

27. The method of modifying nanoparticles according to claim 26 wherein the polymer multidentate ligand is a graft copolymer in which a polymer backbone contains pendant groups bearing the suitable functionality and a remaining portion of the polymer does not bear suitable functionality.

28. The method of modifying nanoparticles according to claim 27 wherein the portion of the polymer which does not bear suitable functionality is selected from the group consisting of polystyrene, polybutadiene, polyisoprene, polydimethylsiloxane, polyacrylates including polyfluoroacrylates, polymethacrylate including polyfluoromethacrylates, polyethylene glycol, poly(acrylic acid) and polymethacylic acid.

29. The method of modifying nanoparticles according to claim 1 wherein the nanoparticles are luminescent nanocrystals.

30. The method of modifying nanoparticles according to claim 1 wherein the nanoparticles are nanocrystals.

31. The method of modifying nanoparticles according to claim 1 wherein the nanocrystals are semiconductor nanocrystals.

32. The method of modifying nanoparticles according to claim 31 wherein the semiconductor nanocrystals are selected from the group consisting of silicon, germanium, indium phosphide, gallium arsenide, cadmium selenide, cadmium teluride, lead sulfide, lead selenide, zinc selenide, zinc sulfide, cadmium sulfide, silver sulfide, copper sulfide and titanium dioxide.

33. The method of modifying nanoparticles according to claim 1 wherein the nanoparticles are CdSe/ZnS quantum nanocrystals.

34. The method of modifying nanoparticles according to claim 1 wherein the nanoparticles are core-shell nanocrystals including a core that is a nanoparticle of one kind of semiconductor, epitaxially overcoated with one or more layers of another semiconductor, wherein successive layers of semiconductor are made of different semiconductor materials.

35. The method of modifying nanoparticles according to claim 1 wherein the nanoparticle is PbS, and wherein said polymer multidentate ligand contains carboxylic acid pendant groups.

36. The method of modifying nanoparticles according to claim 35 wherein the carboxylic acid groups are introduced into the polymer using acrylic acid, methacrylic acid, and/or vinylbenzoic acid as monomers.

37. The method of modifying nanoparticles according to claim 1 wherein the nanoparticles are spherical having a diameter in a range from about 1.2 nm to about 50 nm.

38. The method of modifying nanoparticles according to claim 1 wherein the polymer multidentate ligand includes pendant groups or polymer chains which absorb and emit radiation in the ultraviolet or visible for forming an ultraviolet or visible nanoparticle ink.

39. The method of modifying nanoparticles according to claim 1 including formulating the modified nanoparticles with a suitable binding agent for binding the nanoparticles to a selected surface.

40. The method of modifying nanoparticles according to claim 1 including formulating the modified nanoparticles with an organic or inorganic-based fluorophore and a suitable binding agent for binding the fluorophore to the polymer.

41. The method of modifying nanoparticles according to claim 1 wherein the polymer multidentate ligand includes a backbone, and wherein a total number of repeat units in the backbone ranges from about 10 to about 2500.

42. The method of modifying nanoparticles according to claim 41 wherein the polymer multidentate ligand includes a backbone, and wherein a total number of repeat units in the backbone ranges from about 10 to about 250.

43. A collection of nanoparticles produced using the method of claim 1.

44. A dispersion of nanocrystals comprising:
a plurality of nanocrystal particles in a desired dispersion liquid, a suitable polymer multidentate ligand having first portions bound to a surface of the nanoparticles and a second portion which does not bind to the surface of the nanoparticles, the suitable polymer multidentate ligand being selected so that the first portions which bind to the surface stabilize quantum size-dependent properties of the nanocrystals, and the second portion which does not bind to the surface provides colloidal stability of the nanoparticles in the desired dispersion fluid.

45. The dispersion of nanocrystals according to claim 44 wherein said nanocrystals are monodisperse.
